(19) United States
(12) Patent Application Publication
(10) Pub. No.: US 2025/0085013 A1
(43) Pub. Date: Mar. 13, 2025

(54) Method and Apparatus for Optimizing Control Parameters

(71) Applicant: Siemens Schweiz AG, Zürich (CH)

(72) Inventors: Jin Yan Guan, Tianjin (CN); Ying Qu, Beijing (CN); Cheng Feng, Hangzhou (CN); Xiao Nan Liu, Suzhou, Jiangsu Province (CN)

(73) Assignee: Siemens Schweiz AG, Zürich (CH)

(21) Appl. No.: 18/728,325

(22) PCT Filed: Jan. 25, 2022
(86) PCT No.: PCT/CN2022/073826

§ 371 Date: Jul. 11, 2024

(51) Int. Cl. F24F 11/64; F24F 11/47; F24F 130/10; G05B 13/04

(52) U.S. Cl. CPC F24F 11/64; F24F 11/47; G05B 13/042; G05B 13/048; F24F 2130/10

(57) ABSTRACT

Embodiments of this application relate to control parameter optimization technologies. Various embodiments include methods and apparatus for optimizing control parameters. At least one group of initial control parameters within a preset range is randomly generated, to obtain a group of current control parameters; it is determined whether a number of updates has exceeded a preset threshold, referring to a total number of times that the current control parameters have been changed; the group of current control parameters is changed when the number of updates does not reach the preset threshold; and air conditioning control parameters are optimized according to control parameters corresponding to a comprehensive score of a combination when the number of updates reaches the preset threshold.

### CROSS-REFERENCE TO RELATED APPLICATIONS

This application is a U.S. National Stage Application of International Application No. PCT/CN2022/073826 filed Jan. 25, 2022, which designates the United States of America, the contents of which are hereby incorporated by reference in their entirety.

### TECHNICAL FIELD

This disclosure relates to control parameter optimization technologies. Various embodiments of the teachings herein include methods and/or apparatus for optimizing control parameters.

### BACKGROUND

Air conditioning systems are used for maintaining indoor environments of target spaces such as office buildings, shopping centers and residential apartments at a desired temperature or comfort level. The desired temperature or comfort level is usually achieved by adjusting control parameters. However, depending on the changing weather conditions and different indoor activities, it is still a great challenge to optimize the air conditioning control system and, more specifically, to reduce energy consumption while maintaining the desired comfort level.

### SUMMARY

Various embodiments of the teachings of the present disclosure include methods and apparatus for optimizing control parameters. This may reduce the energy consumption of air conditioning while maintaining the desired comfort level. For example, some embodiments include a method for optimizing control parameters is provided, including: randomly outputting at least one group of initial control parameters within a preset range to obtain at least one group of current control parameters; determining whether a number of updating has exceeded a preset threshold, where the number of updating refers to a total number of times that the current control parameters have been changed; inputting at least one group of current control parameters, a current indoor condition value and a future weather condition value to an energy consumption prediction model and an indoor condition prediction model respectively when the number of updating does not reach the preset threshold; receiving at least one combination, where the at least one combination includes: future energy consumption outputted by the energy consumption prediction model and a future indoor condition outputted by the indoor prediction model; scoring the at least one combination to obtain consumption cost and indoor condition cost of each combination, where the indoor condition cost is used for reflecting a deviation of the outputted future indoor condition from a target indoor condition; calculating a comprehensive score of each combination based on the consumption cost and the indoor condition cost of each combination, where the comprehensive score is used for reflecting a comprehensive cost of the consumption cost and the indoor condition cost; changing the at least one group of current control parameters, and updating the number of updating; returning to the step of determining whether the number of updating has exceeded the preset threshold; and optimizing air conditioning control parameters according to control parameters corresponding to the comprehensive score of the at least one combination when the number of updating reaches the preset threshold.

Some embodiments include an apparatus for optimizing control parameters, configured to perform one or more of the methods described herein.

Some embodiments include an electronic device including a processor and a memory, the memory storing a computer-readable instruction, the computer-readable instruction, when executed by the processor, implementing one or more of the methods described herein.

Some embodiments include a computer-readable storage medium is provided, storing a computer instruction, the computer instruction, when executed, implementing one or more of the methods described herein.

### BRIEF DESCRIPTION OF THE DRAWINGS

The following drawings are intended to give schematic illustrations and explanations of this application, but are not intended to limit the scope of this application. In the drawings:

FIG. 1 is a flowchart of an example method for optimizing control parameters incorporating teachings of the present disclosure;

FIG. 2 is a schematic diagram of an example apparatus for optimizing control parameters incorporating teachings of the present disclosure;

FIG. 3 is a schematic diagram of an example electronic device incorporating teachings of the present disclosure; and

FIG. 4 is a flowchart of an example evaluation process of an evaluation module incorporating teachings of the present disclosure.

Reference numerals are as follows:

| | | |
|---|---|---|
| 100: Method for | 110, 120-127, 130: | |
| optimizing control | Method steps | |
| parameters | | |
| 21: Initial | 22: Determining | 23: Updating |
| module | module | module |
| 24: Evaluation | 25: Optimization | |
| module | module | |
| 300 Electronic | 310 Processor | 320 Memory |
| device | | |

### DETAILED DESCRIPTION

In order to provide a clearer understanding of the technical features, the objectives, and the effects of the teachings of the present disclosure, specific implementations are now illustrated with reference to the accompanying drawings. Many specific details are set forth in the following description to facilitate a full understanding, but the teachings herein may also be implemented in other manners different from those described herein and are therefore not limited by specific embodiments disclosed below.

As shown in this disclosure, words such as “a/an”, “one”, “one kind”, and/or “the” do not refer specifically to singular forms and may also include plural forms, unless the context expressly indicates an exception. In general, terms “comprise” and “include” merely indicate including clearly identified steps and elements. The steps and elements do not constitute an exclusive list. A method or a device may also include other steps or elements.

In this disclosure, by obtaining the energy consumption cost and indoor condition cost corresponding to different groups of control parameters respectively, and then calculating the corresponding comprehensive score based on each combination of the energy consumption cost and the indoor condition cost, the air conditioning control parameters are optimized according to the comprehensive score, so as to properly reduce the energy consumption of air conditioning while maintaining the desired comfort.

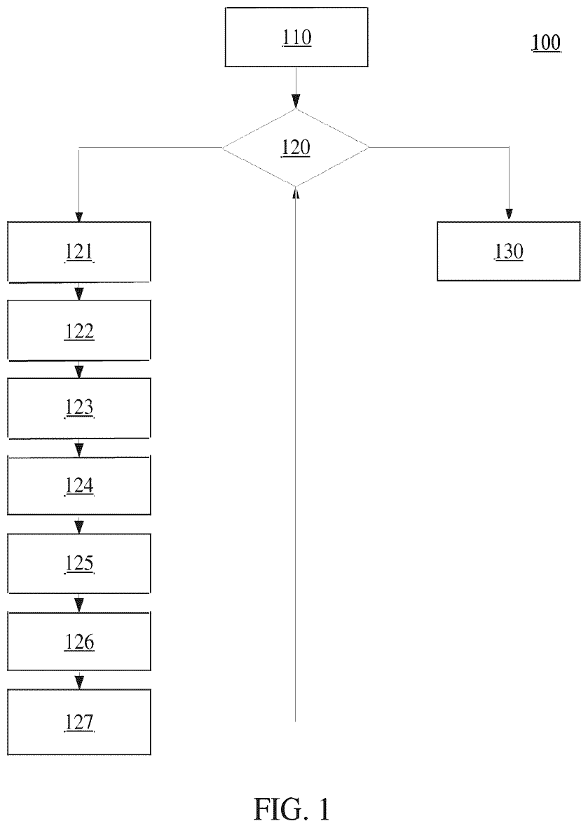

FIG. 1 is a flowchart of an example method for optimizing control parameters incorporating teachings of the present disclosure. The method shown includes:

Step 110: Randomly output at least one group of initial control parameters within a preset range to obtain at least one group of current control parameters. The control parameters of an air conditioner may include temperature and wind speed. For example, the preset range may be a temperature range of 20° C. to 30° C., and a wind speed range of level 1 to level 5. At least one group of initial control parameters in the next N hours may be outputted randomly; In some embodiments, N≤24. For example, one group of air conditioning control parameters in each of the next 24 hours may be outputted randomly as a group of initial control parameters. Alternatively, a plurality of groups may be outputted.

Step 120: Determine whether a number of updating has exceeded a preset threshold. The number of updating refers to a total number of times that the current control parameters have been changed. The preset threshold of the number of updating may be set in advance, or may be set by a user.

Step 121: Input the at least one group of current control parameters, a current indoor condition value and a future weather condition value to an energy consumption prediction model and an indoor condition prediction model respectively when the number of updating does not reach the preset threshold. The current indoor condition value includes at least one of the following: temperature, humidity or carbon dioxide concentration. The future weather condition value includes at least one of the following: temperature, humidity or wind power. In some embodiments, the future weather condition value may be weather condition values in each of the next 24 hours, such as temperature in each of the next 24 hours, humidity in each of the next 24 hours, and wind power in each of the next 24 hours. Prediction results may be closer to a real situation by inputting the current indoor condition value and the future weather condition value to the associated prediction models.

Step 122: Receive at least one combination. The at least one combination includes: future energy consumption outputted by the energy consumption prediction model and a future indoor condition outputted by the indoor prediction model.

In some embodiments, offline training of the energy consumption prediction model may be performed by inputting historical weather data, historical energy consumption data, historical indoor condition data and a historical control parameter to the model. The energy consumption prediction model may be a probabilistic time-series prediction model, such as a Bayesian recurrent neural network. In some embodiments, the energy consumption prediction model may also be established by the following algorithm: μ_{1:t}^{(e)}, σ_{1:t}^{(e)}=g(z₀, a₀, a₁, . . . , aₜ₋₁, x₀, x₁, . . . , xₜ₋₁), where μ_{1:t}^{(e)}, denotes an average value of energy consumption from time-step 1 to time-step t; σ_{1:t}^{(e)} denotes a variance of energy consumption from time-step 1 to time-step t; zₒ denotes an indoor condition at time-step t=0, that is, an initial indoor condition; aₜ denotes weather at time-step t; xₜ denotes a control parameter at time-step t. An energy consumption prediction model with a more accurate prediction result can be obtained by using the foregoing algorithm.

In some embodiments, offline training of the indoor condition prediction model may be performed by inputting historical weather condition data, historical energy consumption data, historical indoor condition data and a historical control parameter to the model. The indoor condition prediction model may be a probabilistic series prediction model, such as a Bayesian neural network. In some embodiments, the energy consumption prediction model may also be established by the following algorithm: μ_{1:t}^{(z)},σ_{1:t}^{(z)}=f (z₀, a₀, a₁, . . . , aₜ₋₁, x₀, x₁, . . . , xₜ₋₁) where μ_{1:t}^{(z)} denotes an average value of energy consumption from time-step 1 to time-step t; σ_{1:t}^{(z)} denotes a variance of an indoor condition from time-step 1 to time-step t; zₒ denotes an indoor condition at time-step t=0, that is, an initial indoor condition; aₜ denotes weather at time-step t; xₜ denotes a control parameter at time-step t. An indoor condition prediction model with a more accurate prediction result can be obtained by using the foregoing algorithm.

Step 123: Score at least one combination to obtain consumption cost and indoor condition cost of each combination. The indoor condition cost is used for reflecting a deviation of the outputted future indoor condition from a target indoor condition. The energy consumption cost may include: cost of average energy consumption; the indoor condition cost may include: cost of an average indoor condition. In some embodiments, the energy consumption cost may include: cost of average energy consumption and cost of the uncertainty in the energy consumption; the indoor condition cost may include: cost of an average indoor condition and cost of the uncertainty in the indoor condition. Higher uncertainty of a value means that a prediction result is less accurate.

In some embodiments, the cost f^{(eμ)} of average energy consumption may be obtained by the following algorithm: f^{(eμ)}=Σₜ₌₁^{T}μₜ^{e}pₜ, where μₜ^{(e)} denotes average energy consumption at time-step t, and pₜ denotes an energy price at time-step t. The cost f^{eσ} of the uncertainty in the energy consumption may be obtained by the following algorithm: f^{eσ}=max(σ₁^{e}, σ₂^{e}, . . . , σ_{T}^{e}), where σₜ^{(e)} denotes a prediction variance of energy consumption at time-step t, and function max( ) denotes taking a maximum value of prediction variances from time-step 1 to time-step T.

The cost of an average indoor condition may include: cost of an average temperature, cost of average humidity and cost of an average carbon dioxide concentration.

The cost f^{(rμ)} of the average temperature may be obtained by the following algorithm: f^{(rμ)}=Σₜ₌₁^{T}(μₜ^{r}−r_{target})², where μₜ^{r} denotes an average temperature at time-step t, and r_{target} denotes a target temperature.

The cost f^{(hμ)} of the average humidity may be obtained by the following algorithm: f^{(hμ)}=Σₜ₌₁^{T}(μₜ^{r}−r_{target}), where μₜ^{r} denotes average humidity at time-step t, and r_{target} denotes target humidity.

The cost f^{(hμ)} of the average carbon dioxide concentration may be obtained by the following algorithm: f^{(hμ)}=Σₜ₌₁^{T}cₜ, where cₜ denotes average carbon dioxide concentration at time-step t.

The cost of the uncertainty in the indoor condition may include: cost of the uncertainty in the temperature, cost of the uncertainty in the humidity, and cost of the uncertainty in the carbon dioxide. The cost f^{(rσ)} of the uncertainty in the temperature may be obtained by the following algorithm: f^{(rσ)}=max(σ₁^{r}, σ₂^{r}, . . . , σ_{T}^{r}), where of denotes a variance of temperature at time-step t.

The cost f^{(hσ)} of the uncertainty in the humidity may be obtained by the following algorithm: f^{(hσ)}=max(σ₁^{h}, σ₂^{h}, . . . , σ_{T}^{h}), where of denotes a variance of humidity at time-step t.

The cost f^{(cσ)} of the uncertainty in the carbon dioxide concentration may be obtained by the following algorithm: f^{(cσ)}=max(σ₁^{c}, σ₂^{c}, . . . , σ_{T}^{c}), where of denotes a variance of carbon dioxide concentration at time-step t.

Step 124: Calculate a comprehensive score of each combination according to the consumption cost and the indoor condition cost of each combination. The comprehensive score is used for reflecting a comprehensive cost of the energy consumption cost and the indoor condition cost.

In some embodiments, the comprehensive score of each combination may be calculated by combining the consumption cost and the indoor condition cost of each combination with preset weights, respectively.

In some embodiments, the energy consumption cost, the indoor condition cost and the comprehensive score of each combination may be sent to a user interface, and the air conditioning control parameters are optimized after a selection of the user is received.

After the comprehensive score of each combination is calculated, the comprehensive score of each combination may be ranked in an ascending order, control parameters corresponding to the top K comprehensive scores may be recorded; where K≥1.

Step 125: Change the at least one group of current control parameters. Step 126: Update the number of updating.

Step 127: Return to step 120.

In some embodiments, at least one group of current control parameters or all current control parameters may be changed by using an evolutionary multi-objective optimization according to the consumption cost and the indoor condition cost of each combination. The evolutionary multi-objective optimization includes heuristic optimization or black-box optimization, or the like. The changes or iterations are oriented towards Pareto solutions that balance a plurality of objectives, that is, balancing the energy consumption cost and the indoor condition cost in next N hours. In some embodiments, the evolutionary multi-objective optimization may be used for balancing the total energy consumption in the next N hours, the deviations of the predicted future indoor condition and the target indoor condition, and the certainty of the related prediction results.

The cost function F in the evolutionary multi-objective optimization may be used to solve multi-objective optimization problems. F={f^{{rμ}},f^{{hμ}},f^{{cμ}}, f^{{eμ}},f^{{rσ}},f^{{hσ}},f^{{cσ}},f^{{eσ}}}, where f^{{rμ}} denotes cost of an average temperature, f^{{hμ}} denotes cost of average humidity, f^{{cμ}} denotes cost of average carbon dioxide concentration, f^{{eμ}} denotes cost of average energy consumption, f^{{rσ}} denotes cost of the uncertainty in temperature, f^{{hσ}} denotes cost of the uncertainty in humidity, f^{{cσ}} denotes cost of the uncertainty in carbon dioxide concentration, f^{{eσ}} denotes cost of the uncertainty in energy consumption. The use of the cost function can further avoid difficulties in selecting weight factors.

Step 130: Optimize air conditioning control parameters according to control parameters corresponding to the comprehensive score of the at least one combination when the number of updating reaches the preset threshold. The air conditioning control parameters may be optimized by using the control parameters corresponding to combinations with higher comprehensive scores, that is, control parameters with acceptable uncertainty costs and relatively low comprehensive scores. In this way, it is possible to obtain control parameters that can achieve higher certainty and properly reduce energy consumption while maintaining a desired comfort level.

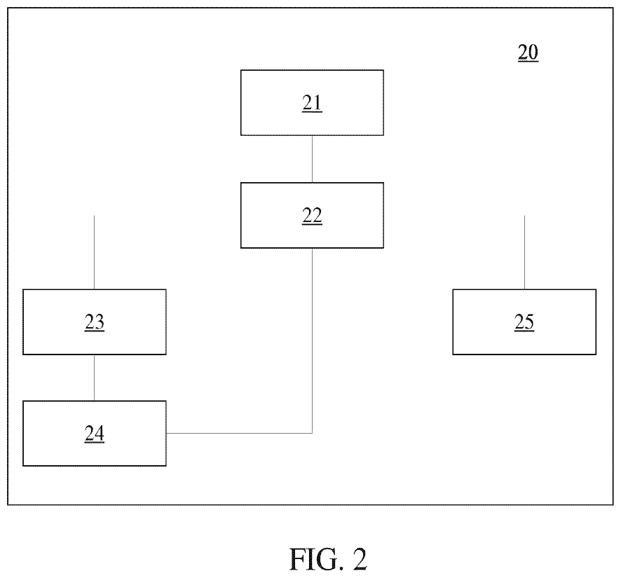

FIG. 2 is a schematic diagram of an example apparatus 20 for optimizing control parameters incorporating teachings of the present disclosure. As shown in FIG. 2, the apparatus 20 for optimizing control parameters includes:
an initial module 21, configured randomly output at least one group of initial control parameters within a preset range to obtain at least one group of current control parameters;
a determining module 22, configured to determine whether a number of updating in an updating 23 has exceeded a preset threshold; where the number of updating to a total number of times that the current control parameters have been changed; and
the updating module 23, configured to change the at least one group of current control parameters when the number of updating does not reach the preset threshold, and update the number of updating.

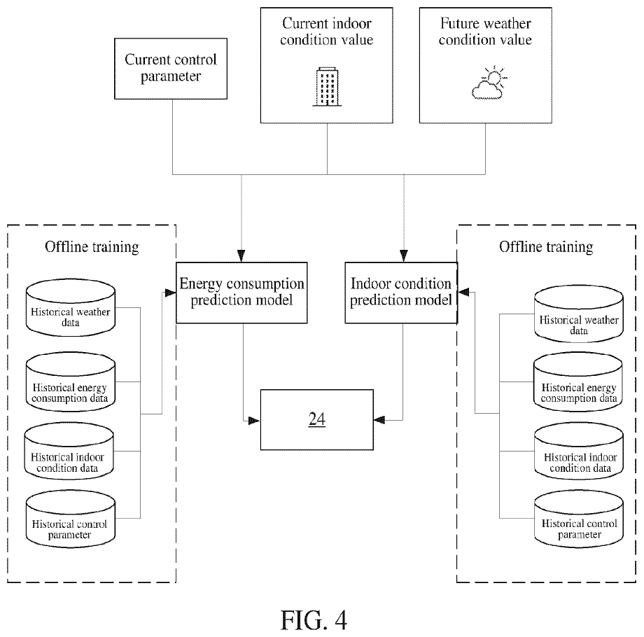

FIG. 4 is a flowchart of an example evaluation process of the evaluation module. As shown in FIG. 4, an evaluation module 24 is configured to input the at least one group of current control parameters, a current indoor condition value and a future weather condition value to an energy consumption prediction model and an indoor condition prediction model respectively; receive at least one combination, where the at least one group includes: future energy consumption outputted by the energy consumption prediction model and a future indoor condition outputted by the indoor prediction model; score the at least one combination to obtain consumption cost and indoor condition cost of each combination, where the indoor condition cost is used for reflecting a deviation of the outputted future indoor condition from a target indoor condition; and calculate a comprehensive score of each combination according to the consumption cost and the indoor condition cost of each combination, where the comprehensive score is used for reflecting a comprehensive cost of the energy consumption cost and the indoor condition cost.

A selection module 25 is configured to optimize air conditioning control parameters according to control parameters corresponding to the comprehensive score of the at least one combination when the number of updating reaches the preset threshold.

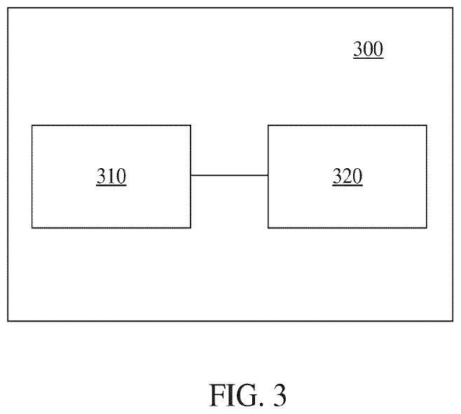

FIG. 3 is a schematic diagram of an example electronic device 300 incorporating teachings of the present disclosure. As shown in FIG. 3, the electronic device 300 includes a processor 310 and a memory 320. The memory 320 stores an instruction, and the instruction is executed by the processor 310 to implement the method 300.

Some embodiments of the teachings herein include a computer-readable storage medium, storing a computer instruction, the computer instruction, when executed, implementing one or more of the methods described herein. For other processing of the foregoing modules, refer to the foregoing method for extracting generated data, which is not repeated here.

Various aspects of the method and apparatus of this application may be entirely executed by hardware, may be entirely executed by software (including firmware, resident software, microcode, and the like), or may be executed by a combination of hardware and software. The foregoing hardware or software may be referred to as “data block”, “module”, “engine”, “unit”, “component” or “system”. A processor may be one or more application specific integrated circuits (ASIC), digital signal processors (DSP), digital signal processing devices (DSPD), programmable logic devices (PLD), field programmable gate arrays (FPGA), processors, controllers, microcontrollers, microprocessors, or a combination thereof. In addition, aspects of this application may be presented as a computer product located in one or more computer-readable media that includes a computer-readable program code. For example, the computer-readable medium may include, but is not limited to, a magnetic storage device (for example, a hard disk, a floppy disk, a magnetic tape . . . ), an optical disk (for example, a compact disk (CD), a digital versatile disk (DVD), . . . ), a smart card, and a flash memory device (for example, a card, a stick, a key driver, . . . ).

The flow diagram is used to describe operations performed by an example method incorporating teachings of the present disclosure. It should be understood that the foregoing operations may not be performed strictly according to the order shown. On the contrary, the operations may be performed in a reverse order or simultaneously. At the same time, or other operations are added into these processes, or one or a plurality of operations are removed from these processes.

It should be understood that each embodiment described may not include only one independent technical solution. The description manner of this specification is merely for clarity. This specification should be considered as a whole by a person skilled in the art, and the technical solution in each embodiment may also be properly combined, to form other implementations that can be understood by a person skilled in the art.

The foregoing are merely specific implementations of this disclosure and are not intended to limit the scope thereof. Any equivalent change, modification, and combination made by a person skilled in the art without departing from the conception and principles of this disclosure should all fall within the protection scope thereof.

What is claimed is:

1. A method for optimizing control parameters, the method comprising:
randomly generating a group of initial control parameters within a preset range to obtain a group of current control parameters;
determining whether a number of updates has exceeded a preset threshold, wherein the number of updates represents a total number of times that the current control parameters have been changed;
when the number of updating does not reach the preset threshold:
entering the group of current control parameters, a current indoor condition value, and a future weather condition value to an energy consumption prediction model and an indoor condition prediction model;
receiving a combination comprising: future energy consumption generated by the energy consumption prediction model and a future indoor condition generated by the indoor prediction model;
scoring the combination to obtain a consumption cost and indoor condition cost of the combination, wherein the indoor condition cost reflects a deviation of the future indoor condition from a target indoor condition;
calculating a comprehensive score for each group according to the consumption cost and the indoor condition cost of the respective, wherein the comprehensive score reflects a comprehensive cost of the consumption cost and the indoor condition cost;
changing the group of current control parameters, and incrementing the number of updates;
and
optimizing a set of air conditioning control parameters using control parameters corresponding to the comprehensive score of the combination when the number of updates reaches the preset threshold.

2. The method according to claim 1, wherein changing the group of current control parameters comprises
changing the group of current control parameters using an evolutionary multi-objective optimization incorporating the consumption cost and the indoor condition cost of each combination.

3. The method according to claim 1, wherein randomly generating a group of initial control parameters comprises
generating a group of initial control parameters in next N hours, wherein N≤24.

4. The method according to claim 1, wherein calculating a comprehensive score of each group according to the consumption cost and the indoor condition cost of each combination comprises
calculating the comprehensive score of each combination by combining the consumption cost and the indoor condition cost of each combination with preset weights.

5. The method according to claim 1, further comprising, after calculating a comprehensive score of each combination, ranking the comprehensive score of each combination in an ascending order, and recording control parameters corresponding to top K comprehensive scores, wherein K≥1.

6. The method according to claim 1, wherein:
the consumption cost comprises a cost of average energy consumption; and
the indoor condition cost comprises a cost of average indoor condition.

7. The method according to claim 1, wherein:
the consumption cost comprises a cost of average energy consumption and cost of the uncertainty in energy consumption; and
the indoor condition cost comprises a cost of an average indoor condition and cost of the uncertainty in indoor condition.

8. The method according to claim 1, wherein:
an offline training method for the energy consumption prediction model comprises
providing historical weather data, historical energy consumption data, historical indoor condition data and a historical control parameter to the energy consumption prediction model for training; and
an offline training method for the indoor condition prediction model comprises
providing a historical weather data, historical energy consumption data, historical indoor condition data and a historical control parameter to the indoor condition prediction model for training.

9. (canceled)

10. An electronic device comprising:
a processor; and
a memory storing a computer-readable instructions;
wherein the computer-readable instruction, when executed by the processor, cause the processor to:
generate a group of initial control parameters within a preset range to obtain at least one group of current control parameters;
determine whether a number of updates in an updating module has exceeded preset threshold, wherein the number of updates represents a total number of times that the current control parameters have been changed;
change the group of current control parameters when the number of updates has not reached the preset threshold and update the number of updates;
provide the group of current control parameters, a current indoor condition value, and a future weather condition value to an energy consumption prediction model and an indoor condition prediction model; receive a combination including: future energy consumption generated by the energy consumption prediction model and a future indoor condition generated by the indoor prediction model; score the combination to obtain consumption cost and indoor condition cost of the combination, wherein the indoor condition cost reflects a deviation of the generated future indoor condition from a tar et indoor condition; calculate a comprehensive score of each combination according to the consumption cost and the indoor condition cost of each combination respectively, wherein the Comprehensive score reflects a comprehensive cost of the consumption cost and the indoor condition cost; and
optimize air conditioning control parameters using the control parameters corresponding to the comprehensive score of the combination when the number of updates reaches the preset threshold.

11. (canceled)
